(19) United States
(12) Patent Application Publication
(10) Pub. No.: US 2026/0314571 A1
(43) Pub. Date: Oct. 15, 2026

(54) Sea Cave

(71) Applicant: Christopher Fisher Goldblatt, Santa Barbara, CA (US)

(72) Inventor: Christopher Fisher Goldblatt, Santa Barbara, CA (US)

(21) Appl. No.: 19/177,214

(22) Filed: Apr. 11, 2025

(51) Int. Cl. A01K 61/73

(52) U.S. Cl. CPC A01K 61/73

(57) ABSTRACT

A system for restoring kelp, coral and/or deep-water marine ecosystems on an ocean seabed and a method for pre-casting sea caves including a mold system configured to be operable for casting sea cave units; a mold system top element having a fill port operable for accepting concrete material; a mold system bottom element having a four-part internal channel configured to allow concrete material to evenly settle without the need for vibration; a clamping system configured to be operable for engaging the mold system top element and mold system bottom element; and at least one or more sea cave units, wherein the one or more sea cave units is configured to be operable for restoring kelp, coral and/or deep-water marine ecosystems on the ocean seabed.

### RELATED CO-PENDING U.S. PATENT APPLICATIONS

The following related U.S. patent application(s), submitted by at least one of the present Applicant(s)/Inventor(s) is/(are) recently co-pending:
U.S. Design patent application Ser. No. 29/809,738, entitled “Domed Structure” , submitted to the United States Patent and Trademark Office (USPTO) on 29 Sep. 2021.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to artificial or man-made reefs. More particularly, certain embodiments of the invention relate to a sea cave reef unit designed to restore kelp, coral and deep-water marine ecosystems.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Coral and kelp reefs are a critical part of the ocean. Although coral reefs may only occupy about 0.01% of the ocean floor, reefs may support roughly 25% of all marine life, providing habitat for a myriad of fish and invertebrate species. Coral and kelp reefs have a significant impact on coastal communities, with one billion people benefiting from their existence. Coral and kelp reefs may provide food and livelihoods, may reduce storm surge and flood risk to coastlines across the tropics, may protect against erosion and attract tourists.

Coral and kelp reefs around the world are in decline due to climate change, pollution, and overfishing. The extent of damage to the world's coral and kelp reefs varies. Hard coral cover has declined significantly in some regions, and there has been a clear change in coral community structure, with loss of susceptible coral and kelp species and loss of diversity.

Pollution, overfishing, destructive fishing practices using dynamite or cyanide, collecting live corals for the aquarium market, mining coral for building materials, harvesting kelp and a warming climate are some of the many ways that people damage coral and kelp reefs all around the world every day.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that artificial reefs may be constructed by intentionally placing dense materials, such as old ships and barges, concrete and steel demolition debris and dredge rock on the sea floor within designated reef sites. Artificial reefs may provide structure on an otherwise sandy bottom seabed to attract marine life, organisms and create a reef habitat. Artificial reefs may provide structure for kelp, algae, invertebrates, corals and fish, increase access to fishing grounds and improve the quality of the catch, reduce erosion and improve surfing conditions and provide an option for managing and conserving fish populations.

Some artificial reefs may be made from plastic or PVC that may break apart, move, and release toxic chemicals. Typical artificial reefs may not look like natural reefs, and corals and marine plants such as kelp may not readily attach to them. Factors that may prevent existing reefing systems from being mass produced may include many molds that are complex with up to about 30 parts and long assembly and removal time. Typical artificial reefs may not stack well. Conventional reefing systems have opening(s) that are generally small and do not open to the seabed. Most artificial reefs are dome or triangle shaped making large opening to the sea floor hard to build into the design.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary stacked precast sea cave molds, in accordance with an embodiment of the present invention;

FIG. 2 is an illustration of an exemplary precast sea cave form/mold, in accordance with an embodiment of the present invention;

FIG. 3 is an illustration of an exemplary underside of Sea Cave unit, in accordance with an embodiment of the present invention;

FIG. 4 is an illustration of an exemplary stacking of precast sea cave molds/forms, in accordance with an embodiment of the present invention;

FIG. 5 is an illustration of an exemplary reef plant, in accordance with an embodiment of the present invention;

FIG. 6 is an illustration of an exemplary form/mold for casting sea cave units, in accordance with an embodiment of the present invention;

FIG. 7 is an illustration of an exemplary form/mold for casting sea cave units, in accordance with an embodiment of the present invention;

FIG. 8 is an illustration of an exemplary implementation of form/mold system bottom element, in accordance with an embodiment of the present invention;

FIG. 9 is an illustration of an exemplary form/mold for casting sea cave units, in accordance with an embodiment of the present invention;

FIG. 10 is an illustration of an exemplary clamping system 1000, in accordance with an embodiment of the present invention;

FIG. 11 is an illustration of an exemplary method of casting sea cave units, in accordance with an embodiment of the present invention;

FIG. 12 is an illustration of an exemplary method of casting sea cave units 200, in accordance with an embodiment of the present invention; and

FIG. 13 is an illustration of an exemplary method of removing sea cave units from a mold system bottom element, in accordance with an embodiment of the present invention.

Unless otherwise indicated, illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. July 3, 1997) (unpublished) Hybridtech v. Monoclonal Antibodies, Inc., 802F.2d 1367, 1385, 231 USPQ 81, 94 (Fed. Cir. 1986), cert. denied, 480 U.S. 947(1987 ). In addition, the use of modifiers in the claim, like “generally” and “substantial,” does not by itself render the claims indefinite. See Seattle Box Co. v. Industrial Crating & Packing, Inc., 731F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347F.3d 1314, 1322 (Fed. Cir. 2003); Epcon Gas Sys., Inc. v. Bauer Compressors, Inc., 279F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355F.3d 1361, 69 USPQ 2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347F.3d 1314, 68 USPQ 2d 1716, 1721 (Fed. Cir. 2003), cert. denied, 124 S. Ct. 1426(2004 ) where the court was asked to construe the meaning of the term “substantially” in a patent claim. Also see Epcon, 279F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279F.3d 1022 (Fed. Cir. 2002) (construing the terms “substantially constant” and “substantially below”); Zodiac Pool Care, Inc. v. Hoffinger Indus., Inc., 206F.3d 1408 (Fed. Cir. 2000) (construing the term “substantially inward”); York Prods., Inc. v. Cent. Tractor Farm & Family Ctr., 99F.3d 1568 (Fed. Cir. 1996) (construing the term “substantially the entire height thereof”); Tex. Instruments Inc. v. Cypress Semiconductor Corp., 90F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims): “Comprising” And “contain” and variations of them-Such terms are open-ended and mean “including but not limited to”. When employed in the appended claims, this term does not foreclose additional structure or steps. Consider a claim that recites: “A memory controller comprising a system cache.” Such a claim does not foreclose the memory controller from including additional components (e.g., a memory channel unit, a switch).“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s). Furthermore, any statement(s), identification(s), or reference(s) to a structure(s) and/or element(s) that corresponds to and/or supports a claim limitation(s) phrased in functional limitation terms covered by 35 USC § 112(6) (post AIA 112(f)) should be understood to be identified by way of example and not limitation, and as such, should not be interpreted to mean that such recited structure and/or element is/are the only structure(s) and/or element(s) disclosed in this patent application that corresponds to and/or supports such claim limitations phrased in functional limitation terms. This claims interpretation intention also applies to any such subsequent statements made by Applicant during prosecution.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In some embodiments of the present invention and variations thereof, relate to artificial reefs. In one embodiment of the present invention, sea cave reef unit is designed to restore kelp, coral and deep-water marine ecosystems. The sea cave reef unit may comprise, without limitation, unique two-part form and/or mold system where concrete may easily and quickly be poured in approximately one (1) minute. The sea cave form and/or mold may allow for mass production which is a long-standing issue with man-made reefing systems. There is no need for air bladders or complex rebar or multi stage systems or multiple fill ports as is seen in other versions. The stripping/removal of the final Sea Cave unit is much faster as the lid is simply removed and the concrete unit is lifted out with crane and it is ready to use and deployed in the ocean's seafloor with no further work. The extra wide mouth (e.g. fill port) at the top of the mold and/or form is unique and allows for large amounts of concrete to be loaded very quickly. The unique 4-part internal channel system may allow concrete to settle uniformly into the entire mold and/or form without the need for vibration (e.g. used to compact concrete).

The present invention will now be described in detail with reference to embodiments thereof as illustrated in the accompanying drawings.

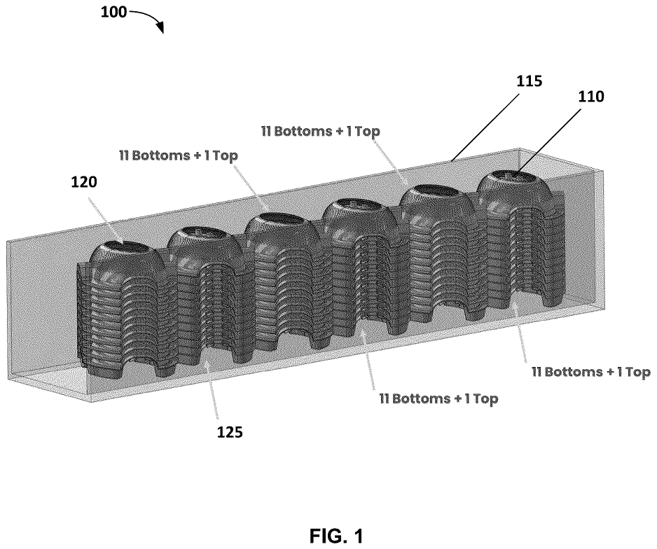

FIG. 1 is an illustration of an exemplary stacked precast sea cave mold units 100, in accordance with an embodiment of the present invention. Each sea cave may include a top opening 110. The Sea Cave mold system is unique in its ability to easily nest into a standard cargo container 115. With bottoms 125 and tops 120 nesting in one another and stabilizing inside container 115 for efficient transportation, as shown.

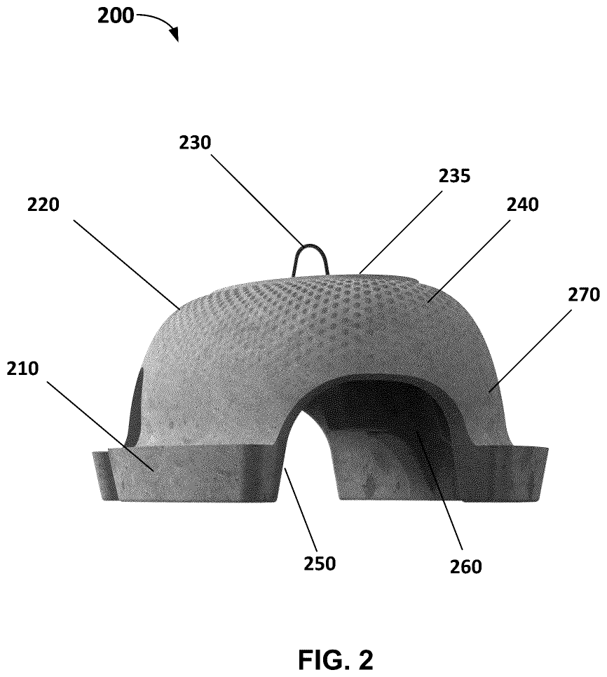

FIG. 2 is an illustration of an exemplary precast sea cave mold unit 200 in accordance with an embodiment of the present invention. Precast sea cave mold unit 200 may comprise, without limitation, a two-part precast sea cave form/mold designed for high speed and scalable production of Sea Cave Biogenic Reefing units.

In one embodiment, the first part of the two-part precast sea cave mold may include lid 235. The lid is oval, oblong or turtle shaped of about one (1) meter diameter with small indentation to emulate natural reef surface. Lid 235 may include, without limitation, a handle 230. The lid may be lifted by hand or crane using handle 230. The lid may be made of fiberglass and resin applied to a release agent lined master template in layers until complete. Alternatively, the lid can be manufactured from cross-linked high density polyethylene (HDPE) via a rotational molding tooling. In this method, HDPE pellets may be placed in tooling, then heated in a rotational molding carousel. Once the molded lids have been allowed to cool, they may then be removed from the tooling.

In another embodiment, the second part of the two-part precast sea cave mold is bottom 125. The bottom may include, without limitation, more or less four elevated independent feet 270 for easy lifting and nested stacking, leg contact surface 210, sea cave main body 220, interior wall 260, main body surface area 240, and openings/channels 250. Precast sea cave unit 200 may be made of, without limitation, concrete, green concrete, aggregate replacement (e.g. papercrete), ashcrete, micro silica, blast furnace slag, etc. Main body surface area 240 may include, without limitation, bumps, ridges, protuberance, etc. for corals and/or kelp to attach or cling itself to and grow. Legs 270 may include more or less four (4) legs for supporting and raising sea cave main body 220 of the seabed. Leg contact surface 210 may include tapered leg contact surface. Interior wall 260 may provide a hiding place for marine life like shrimp, small fish and lobster. Openings/Channels 250 provide marine life an entry way to interior wall 260.

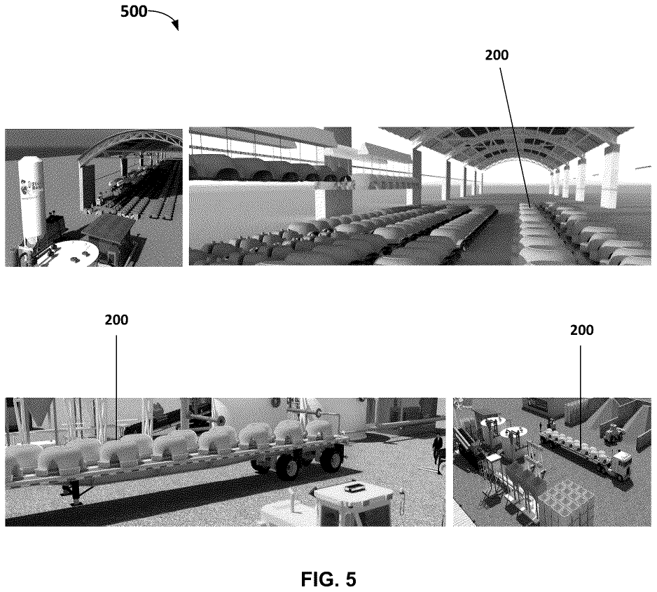

In other embodiments, the Sea Cave design may allow easy stacking of the sea caves. Sea Cave forms and/or molds 200 themselves nest well in a container so the precast sea caves may be easily mobilized and demobilized. Roughly three (3) or more precast sea caves 200 to become future marine reefs may be loaded onto trucks and vessels during transport (see FIG. 5).

In further embodiments, the form and function of the final sea cave unit may be highly unique in its ability to sustain large amount of kelp plants and large fish due to large openings 250 that are open to the seafloor. Large openings/channels 250 between legs 270 may allow for easy flow of water and sand to interior wall 260 allowing sea caves 200 to not become sunken into the seabed.

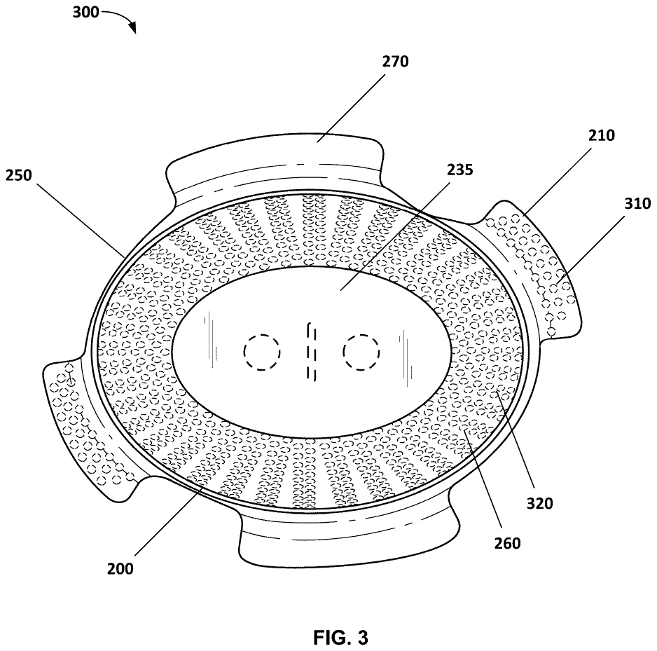

FIG. 3 is an illustration of an exemplary underside 300 of precast Sea Cave unit 200, in accordance with an embodiment of the present invention. In one embodiment of the present invention, interior wall 260 may include rough surfaces 320 such as, without limitation, bumps, protuberance, ridges, etc. Rough surface 320 may enable marine life to lay eggs. Contact surfaces 210 of legs 270 may include rough surface 310 such as, without limitation, bumps, protuberance, ridges, etc. to enable contact surfaces 210 to grab the seabed and prevent movement. In other embodiment, interior wall 260 creates an interior chamber for fish to hide and lay eggs. Openings/channels 250 may comprise at least four openings/channels 250. The combination of openings/channels 250 and interior wall 260 provides a hiding place for marine life such as small fish, shrimp and lobster.

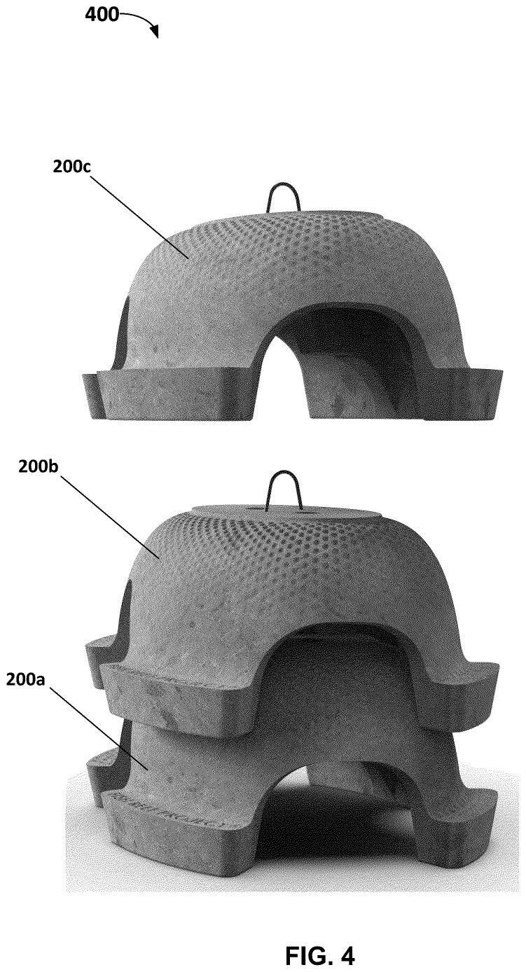

FIG. 4 is an illustration of an exemplary stacking of precast sea cave molds/forms 200a-c, in accordance with an embodiment of the present invention. In certain embodiments of the present invention, roughly five inches (5″) tapered center wall 240 is a unique feature that enables stacking of sea caves 200a-c during transport.

FIG. 5 is an illustration of an exemplary reef plant 500, in accordance with an embodiment of the present invention. Reef plant 500 shows shipping and handling of sea cave units 200.

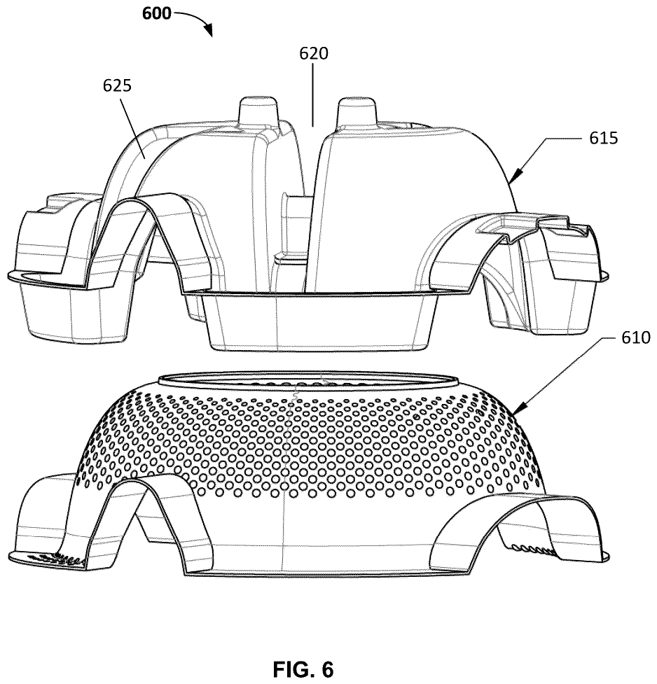

FIG. 6 is an illustration of an exemplary form/mold system 600 for casting sea cave units 200, in accordance with an embodiment of the present invention. In one embodiment of the present invention, form/mold system 600 may include, without limitation, a two-part mold system for casting sea cave units 200 that fills more quickly than typical precast forms. Two-part mold system 600 may comprise, without limitation, a mold system top element 610 and a mold system bottom element 615. Mold system top element 610 may weigh around 85 lbs. and mold system bottom element 615 may weigh roughly 132 lbs.

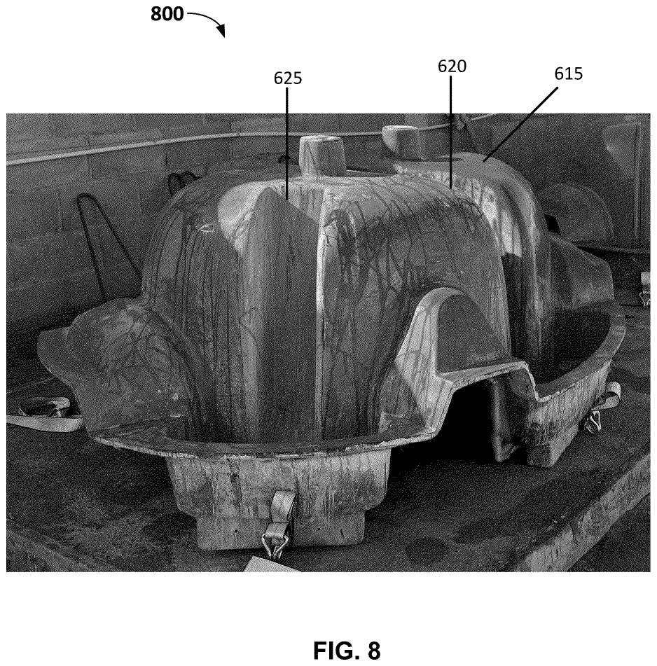

In some embodiments, mold system bottom element 615 may include, without limitation, a four-part internal channel system. Four-part internal channel system may comprise, without limitation, at least four (4) tapered channels including main channel 620 and shoulder style channels 625. Main channel 620 runs down the full center of mold system bottom element 615 and then two small shoulder style channels 625 runs on the proximate far ends of the bottom of the mold (also see FIG. 8). The four-part internal channel system may allow a concrete material to flow and settle uniformly into the entire mold and/or form without the need for vibration (e.g. used to compact concrete).

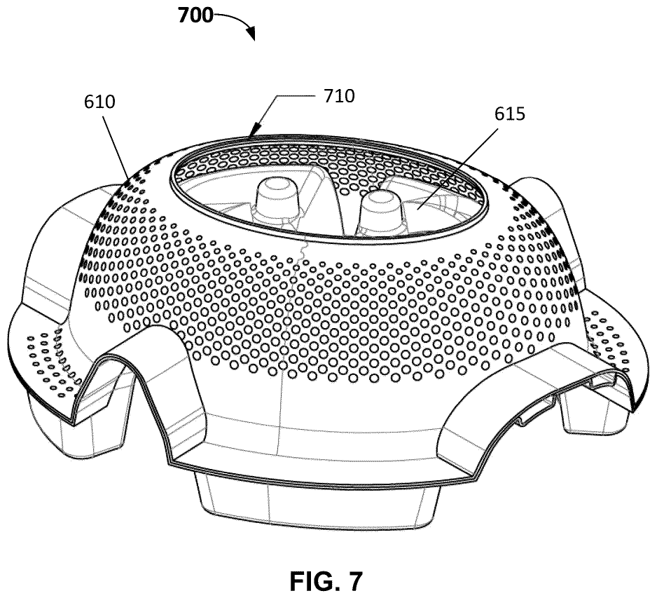

FIG. 7 is an illustration of an exemplary form/mold system 700 for casting sea cave units 200, in accordance with an embodiment of the present invention. In one embodiment of the present invention, mold system top element 610 may be into engagement with mold system bottom element 615 using, without limitation, clamps and nuts and bolts. In other embodiments, mold system top element 610 may include, without limitation, a trimmed center cap 710. Trimmed center cap 710 comprises a fill port for accepting concrete material and enable the concrete material to flow.

FIG. 8 is an illustration of an exemplary implementation 800 of form/mold system bottom element 615, in accordance with an embodiment of the present invention. In one embodiment of the present invention, a four-part internal channel system may allow concrete to settle uniformly into the entire mold and/or form without the need for vibration (e.g. used to compact concrete). Mold system bottom element 615 may include, without limitation, four (4) tapered channels 620 625. Main channel 620 runs down the full center and two small shoulder style channels 625 runs on the far ends of the bottom of the mold.

In some embodiments, mold system bottom element 615 may comprise, without limitations, about four (4) part tapered channel system 620 625 that enables concrete to flow at approximately 70 meters per hour without backing up or stalling the process. Channels 620 625 may allow concrete to easily settle in every orifice of the mold systems with reduced need for vibration to allow settling.

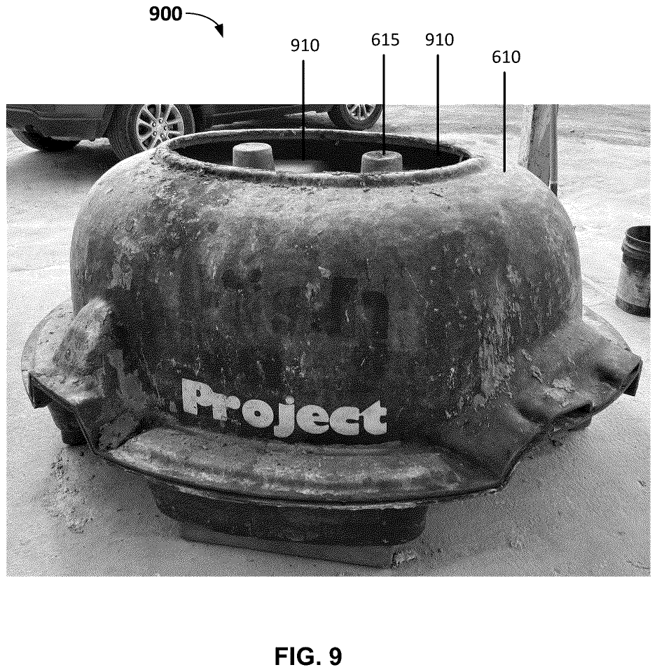

FIG. 9 is an illustration of an exemplary mold implementation 900 of form/mold system 700 for carrying out the casting of sea cave units 200, for example, without limitations, in reef plant 500, in accordance with an embodiment of the present invention. In one embodiment of the present invention, mold system top element 610 may be coupled with mold system bottom element 615 using, without limitation, clamps and nuts and bolts. A top opening 910 may enable concrete to be injected. Mold system top element 610 and mold system bottom element 615 may be made with, without limitations, rotational plastic molding system, fiberglass or steel. Dugout forms, shaped forms, and/or latex forms may also be used.

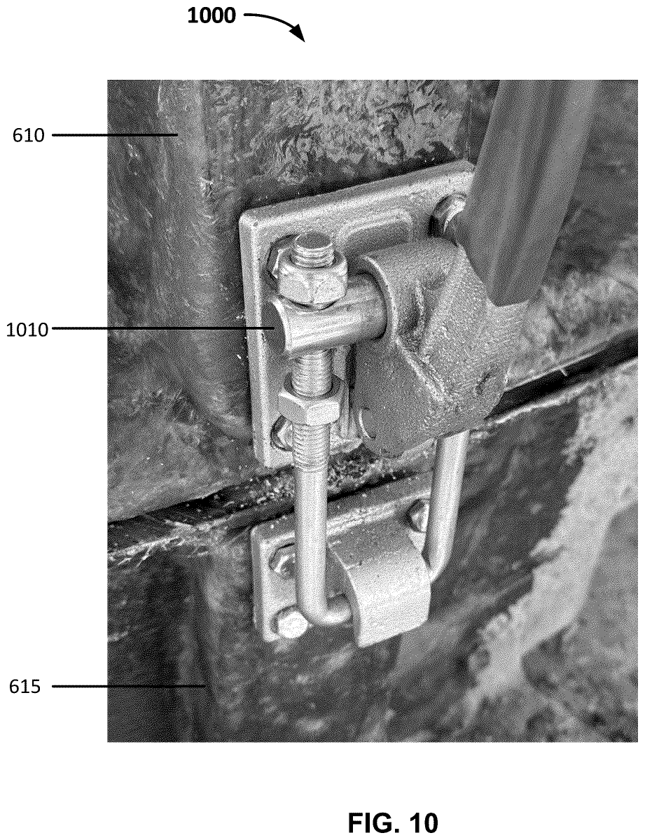

FIG. 10 is an illustration of an exemplary clamping system 1000, in accordance with an embodiment of the present invention. In one embodiment of the present invention, clamping system 1000 may carry out a coupling of mold system top element 610 with mold system bottom element 615, as shown. Clamping system 1000 may include, without limitations, clamps, nuts and bolts, at least four (4) clamp implements and may be clamped shut to ensure a good seal and no concrete leakage once filled. The clamping system may be affixed at four hardened points placed at equal distances from each other around the lip/flange of the molds where the top and bottom connect. Alternatives to clamps, such as, but not limited to, turn-buckles, tie downs, or toggle clamps may also be used.

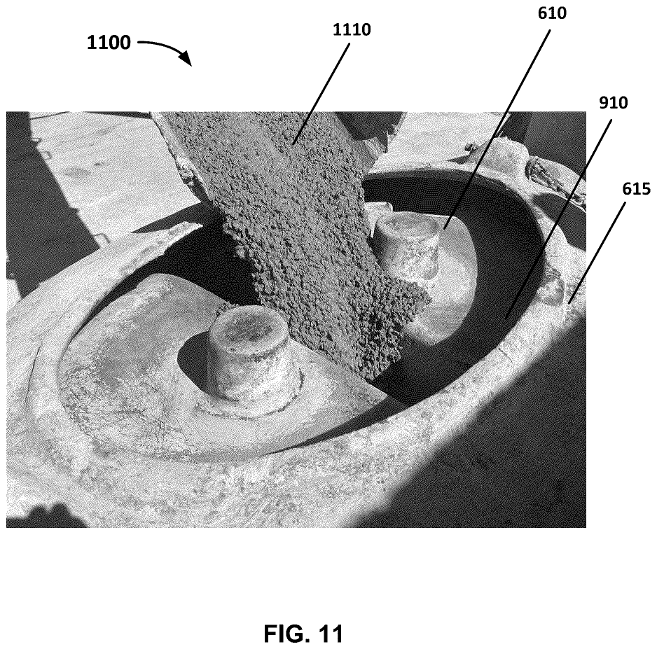

FIG. 11 is an illustration of an exemplary method of casting sea cave units 200, in accordance with an embodiment of the present invention. In one embodiment of the present invention, a first step in carrying out the casting of sea cave units 200 may include, without limitation, a pouring of material(s) 1110 into a top opening/fill port 910 of form/mold system 900. The proscribed concrete mix design is preferred for this application, however Sea Caves according to embodiments of the present invention may be made with variable marine concrete mix designs including, but not limited to, non pH neutralized concrete, variable sizes of micro fibers, variable densifiers and variable cement types, etc. Top opening 910 may include, without limitation, an extra wide fill port. In this configuration, the oval fill port measures 39.5 inches at the longest point and 23.5 inches at the narrowest point. Top opening/fill port 910 may further include, without limitation, oval, oblong, round, square, triangular and/or turtle shell shaped fill port. The extra wide fill port mouth allows for large amounts of material(s) 1110 to be loaded very quickly. Material(s) may include, without limitation, concrete, green concrete, aggregate replacement (e.g. papercrete), ashcrete, micro silica, blast furnace slag, etc.

In some embodiments, a method of casting precast sea caves may include, without limitation, pouring concrete in the mold in the first step, let sit around twelve-sixteen hours in a second step, remove lid 235 in a third step and remove finished Sea Cave 200 in a fourth step. No air bladder, no complex rebar and no force needed.

In other embodiments, form/mold system 900 may allow the user to order concrete in a ready-mix truck and pour concrete through top opening 910. Around twelve to sixteen (12-16) hours later, lid 235 may be removed then the finished concrete Sea Cave unit 200 may be removed and precast unit 200 is ready to be placed on the seafloor of the ocean.

In further embodiments, top opening 910 may comprise a very large oval shaped opening of about one (1) meter diameter. This may enable concrete to pour at a rate of around seventy (70) meters per hour to substantially fill the entire mold in less than one minute. This is at least 3 times faster than other similar designs.

In some embodiment, two-part precast mold system may fill more quickly than typical precast forms. Usual cast for similar reef units may require a complex air bladder system of small and large air bladders that must be carefully put into position, greases, filled with air, concrete poured, then removed by force (for example, removal with a forklift pulling upwards on the air bladder).

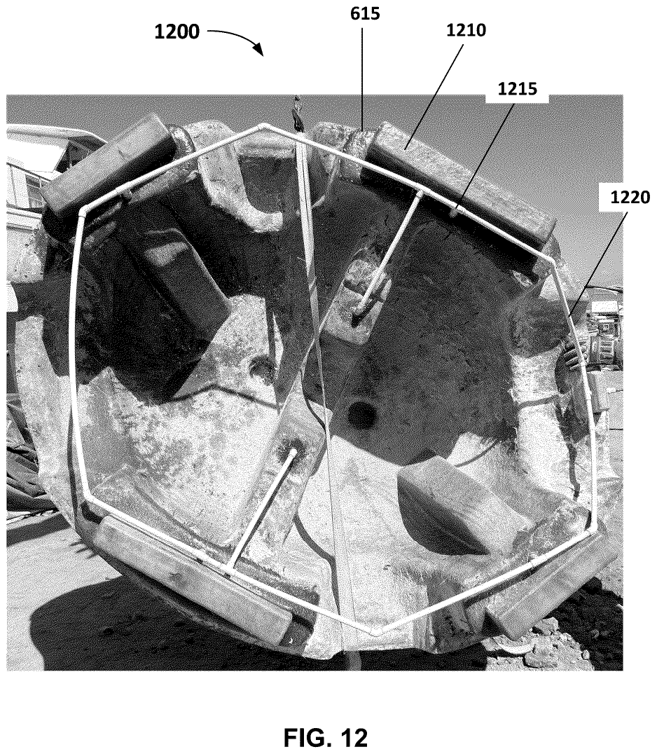

FIG. 12 is an illustration of an exemplary method of casting sea cave units 200, in accordance with an embodiment of the present invention. In one embodiment of the present invention, air entrained feet 1210 for force releasing concrete form 200 may be novel as usually grease is used. Air fittings 1215 on air entrained feet 1210 are installed. Air pipes 1220 may be built into four (4) feet 1210 of mold system bottom element 615. Air pipes 1220 and/or air fittings 1215 may comprise, without limitation, metals like aluminum, stainless steel, copper, galvanized steel and/or plastic such as PVC pipes shown on bottom of the mold. A blast of compressed air through air pipes 1220 may easily cause the concrete sea cave unit to break free from mold system 900 for easy removal. When compressed air is applied to air pipes 1220 via air fittings 1215, concrete unit 200 may easily pop out. This step is not usually done in conventional precast concrete systems. The use of air pressure does not need a slick release agent usually used in conventional precast concrete systems. In addition, conventional precast concrete systems release agents that are generally petroleum based and bad for the marine ecosystem. The use of compressed air may fix petroleum-based pollution issues while ensuring concrete sea cave 200 does not crack from excess pressure that would be applied otherwise during removal. In the present application, it is contemplated that 30 PSI is an optimal air pressure to force the release of the concrete unit from the mold.

In another embodiment, shapes and angles designed into the sea cave mold may allow for easy release of the concrete sea cave 200 from the mold. By adding the proper amount of “taper” to all contact surfaces 210 of legs 270, easier removal of the dry concrete may be achieved. For example, without limitation, similar to an ice cube tray that is tapered for the same reason, to allow ice to release vs vertical surfaces resist release. It is contemplated that an optimal taper is an average graduation of 1-2 inches across all angles in the Sea Cave mold for the present casting method.

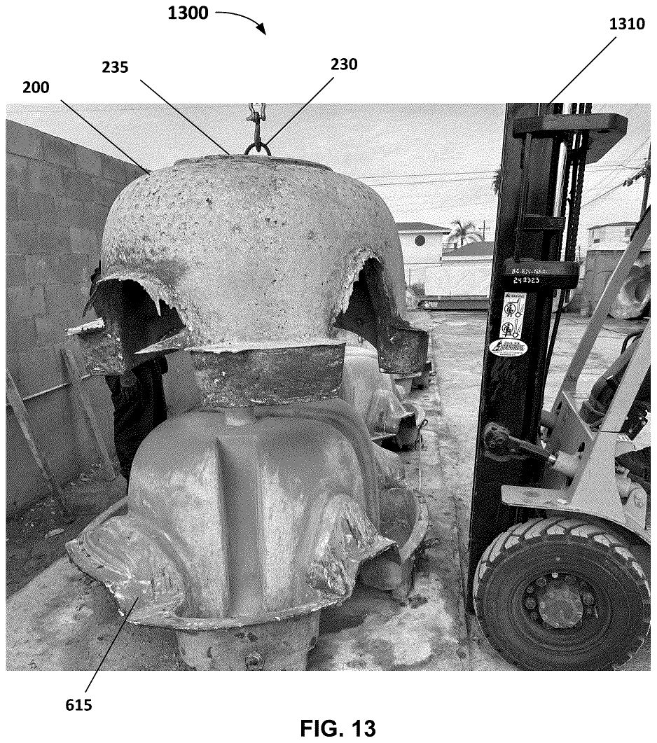

FIG. 13 is an illustration of an exemplary method of removing sea cave units 200 from mold system bottom element 615, in accordance with an embodiment of the present invention. In one embodiment of the present invention, concrete unit 200 is lifted out with a crane 1310, as shown, ready for deployment and use on the ocean's seafloor. In some embodiment, the stripping/removal of the final Sea Cave unit 200 is much faster as lid 235 is simply removed with handle 230 and the concrete unit 200 is lifted out (e.g. with crane 1310) and Sea Cave unit 200 is ready to use and deployed in the ocean with no further work. Once the lid is removed by crane or by hand, it may be set aside as the Sea Cave concrete unit is hoisted free from the mold. The lid's job is complete at this time and may be cleaned, re assembled and affixed to the mold bottom for the next concrete pouring.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented automatically using any physical and/or hardware system that those skilled in the art will readily know is suitable in light of the foregoing teachings. For any method steps described in the present application that can be carried out automatically on a computing machine, a typical computer system may, when appropriately configured or designed, serve as a computer and control system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claim's construction proceedings and/or examination of patent allowability properly identify and incorporate only the portions of each of these documents discovered during the broadest interpretation search of 35 USC § 112(6) (post AIA 112(f)) limitation, which exist in at least one of the patents and/or non-patent documents found during the course of normal USPTO searching and or supplied to the USPTO during prosecution. Applicant(s) also incorporates by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) notes that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing the sea cave reef unit(s) according to the present invention will be apparent to those skilled in the art. Various aspects of the invention have been described above by way of illustration, and the specific embodiments disclosed are not intended to limit the invention to the particular forms disclosed. The particular implementation of the sea cave reef unit(s) may vary depending upon the particular context or application. By way of example, and not limitation, the sea cave reef unit(s) described in the foregoing were principally directed to restoring kelp, coral and deep-water marine ecosystems implementations; however, similar techniques may instead be applied to fish/lobster farming, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A system comprising:
a mold system, wherein said mold system is configured to be operable for casting sea cave units, and wherein said one or more sea cave units is/are configured to be operable for restoring kelp, coral and/or deep-water marine ecosystems on an ocean seabed;
a mold system top element, wherein said mold system top element comprise a fill port operable for accepting concrete material;
a mold system bottom element, wherein said mold system bottom element comprise a four-part internal channel configured to allow concrete material to evenly settle without the need for vibration;
a clamping system, wherein said clamping system is configured to be operable for engaging said mold system top element and mold system bottom element; and
at least one or more sea cave units configured to be operable for restoring kelp, coral and/or deep-water marine ecosystems on the ocean seabed.

2. The system of claim 1, wherein said one or more sea cave units comprise:
a lid;
a handle configured for lifting said lid;
a sea cave main body configured to receive said lid; and
at least four legs operable for elevating and supporting said sea cave main body above the ocean seabed.

3. The system of claim 2, wherein said one or more sea cave units further comprise:
an interior wall, wherein said interior wall is configured to provide a habitat for marine life like at least one of, shrimp, fish and lobster; and
at least four channels, wherein said channels are configured to provide an entry for marine life to said interior wall.

4. A system comprising:
a mold system, wherein said mold system is configured to be operable for casting sea cave units;
a mold system top element operable for accepting concrete material;
a mold system bottom element configured to allow concrete material to settle without the need for vibration;
a clamping system, wherein said clamping system is configured to be operable for engaging said mold system top element and mold system bottom element; and
at least one or more sea cave units, wherein said one or more sea cave units is/are configured to be operable for restoring kelp, coral and/or deep-water marine ecosystems.

5. The system of claim 4, wherein said mold system top element comprise a fill port operable for accepting concrete material.

6. The system of claim 5, wherein said mold system bottom element further comprise a four-part internal channel configured to allow concrete material to flow and settle in said mold system bottom element without the need for vibration.

7. The system of claim 5, wherein said one or more sea cave units comprise:
an interior wall, wherein said interior wall is configured to provide a habitat for marine life;
a sea cave main body configured to support said interior wall;
at least four channels, wherein said channels are configured to provide an entry way for marine life to said interior wall; and
at least three or more legs operable for elevating and supporting said sea cave main body above the ocean seabed.

8. The system of claim 7, wherein said one or more sea cave units further comprise:
a lid configured to cover said fill port; and
a handle configured for lifting said one or more sea cave units.

9. The system of claim 4, further comprising an air system, wherein said air system is configured to be operable for separating said mold system and a formed sea cave unit when compressed air is applied.

10. The system of claim 9, wherein said air system comprise:
at least one or more air pipes;
at least one or more air fittings; and
wherein compressed air is applied to said air pipes and travels through said air fittings and separates said mold system and the formed sea cave unit.

11. The system of claim 4, wherein said one or more sea cave units are configured to nest on top of each other for transport.

12. The system of claim 4, wherein said three or more legs comprise tapered legs that are configured to be operable for releasing said sea cave units from said mold system using compressed air.

13. A system comprising:
a mold system, wherein said mold system is configured to be operable for casting or forming one or more sea cave units;
wherein said one or more sea cave units are configured to be operable for restoring kelp, coral and/or deep-water marine ecosystems on an ocean seabed or seafloor;
a mold system top element, wherein said mold system top element comprise a fill port operable for accepting concrete material;
a mold system bottom element, wherein said mold system bottom element comprise internal channels configured to allow concrete material to evenly settle without the need for vibration;
a clamping system, wherein said clamping system is configured to be operable for engaging said mold system top element and mold system bottom element; and
an air system, wherein said air system is configured to be operable for separating said mold system and a formed sea cave unit.

14. The system of claim 13, wherein said sea cave units comprise:
an interior wall, wherein said interior wall is configured to provide a hiding place for marine life including at least one of, a shrimp, a fish and a lobster;
a sea cave main body configured to support said interior wall;
at least three or more channels, wherein said channels are configured to provide an entry way for marine life to said interior wall; and
at least three or more legs operable for elevating said sea cave main body above the ocean seabed.

15. The system of claim 13, wherein said air system comprise:
at least one or more air pipes;
at least one or more air fittings; and
wherein when compressed air is applied to said air pipes and travels through said air fittings separates said mold system and the formed sea cave unit.
